(19) United States
(12) Patent Application Publication
(10) Pub. No.: US 2002/0161652 A1
(43) Pub. Date: Oct. 31, 2002

(54) System and method for inventory monitoring and control of household consumable items

(76) Inventors: Andrew Rhodes Paullin, Woburn, MA (US); Jonathan William Singer, Stamford, CT (US)

Correspondence Address: Mr. Andrew Rhodes Paullin, 88 Hammond Place, Woburn, MA, 01801, US

(21) Appl. No.: 10/062,934

(22) Filed: Jan. 31, 2002

Related U.S. Application Data
(60) Provisional application No. 60/265,861, filed on Jan. 31, 2001.

(51) Int. Cl. G06F 17/60

(52) U.S. Cl. 705/22

(57) ABSTRACT

A system and method for inventory monitoring and control of household consumable items using at least one smart container. A smart container implements an ID tag and one or more sensors to determine the type and amount remaining of a household consumable item it contains. The modular nature of a smart container enables the system to monitor and control the inventory of such items wherever they are located within home storage areas. The smart containers communicate with a container interface unit, which in turn communicates with a logic processing unit that uses novel methods to monitor and control the inventory of any or all household consumable items. A global access unit communicates with other devices on the internet to execute the monitoring and control methods. Any one or more of these three units can be constructed as part of, or be located inside or outside, home storage areas.

### CROSS-REFERENCE TO RELATED APPLICATIONS

Embodiments of the present invention claim priority from U.S. provisional patent application Serial No. 60/265,861 entitled “METHOD AND APPARATUS FOR REFRIGERATOR INVENTORY CONTROL,” filed Jan. 31, 2001, the contents of which are incorporated herein by reference for all purposes.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention generally relates to inventory monitoring and control systems, and more specifically to a novel household consumable items inventory monitoring and control system and method using at least one smart container.

As discussed herein, much prior art exists in the area of inventory monitoring and control systems, though mostly related to an industrial setting. The advent of the internet age has recently refueled the concept of smart homes, resulting in more and more household devices wired to the internet. The present invention as discussed herein adds an additional household device to this list.

Refrigerators wired to the internet that can automatically monitor and control the inventory of their contents using sensors constructed as part of the refrigerator became known with U.S. Pat. No. 6,204,763, including lock boxes having both refrigerated and unrefrigerated compartments with both an indoor and outdoor access. One of the main disadvantages of that invention is that it requires, and even recommends, having a dedicated place or compartment to store each household consumable item. This is very undesirable to the users of the household consumable items, as it requires a conscious effort on their part to remember to put the items back in the proper location. Otherwise if an item is in the wrong location it will generate a false reading for a different item, and itself therefore will not be detected by the system.

Similarly, the just mentioned, previously invented household consumable items inventory monitoring and control system does not address the possibility that household consumable item consumers in different households may have different storage area size requirements. Some users may like more space for one item, while others for a different item. With areas dedicated to each item, it is not possible to meet the needs of various consumers.

Furthermore, the previously mentioned invention also requires a new type of home storage area to be constructed, such as a new type of refrigerator or lock box with built in sensors. Such a requirement is disadvantageous to both appliance manufactures and consumers, as it requires the appliance manufactures to change their existing designs, including constructing a dedicated communications port therein, and likewise it requires consumers to purchase a new home storage area, such as a new refrigerator or lock box.

The household consumable items inventory monitoring and control system invented herein specifically addresses and alleviates these disadvantageous by using one or more smart containers to monitor the amount remaining and identification of one or more household consumable items they contain, wherever such items are located within existing home storage areas.

Several other inventions exist that address the problem of food spoilage by monitoring the time that a particular food item has been in a refrigerator. Such inventions are discussed in detail in U.S. Pat. Nos. 5,711,160, 5,487,276, 5,335,509, and several other patents referenced therein. While such inventions are novel for that purpose, they fail to recognize the need to also measure the quantity of each food item remaining in order to create an effective food monitoring system. For example, in addition to the fact that the user would be notified that the milk in their refrigerator is about to expire, it would be more beneficial if they were also notified that they still have three-quarters of a gallon remaining, so they can plan their consumption accordingly so as to not waste the milk. Such a scenario is possible with the present invention, in addition to the novel method also invented herein to predict when a user is going to run out of a particular food product based on their rate of use of that product in the past. This way new food items can automatically arrive at their door, or be picked up, just as they are about to run out. Such a feature will further reduce the amount of wasted food by implementing this just in time inventory concept to household consumable items.

A similar system to monitor food freshness using humidity, temperature, and acidity sensors, including monitoring the time the food item has been inside or outside the refrigerator, has been invented with U.S. Pat. Nos. 5,969,606 and 5,798,694. While novel in that art, again these inventions fail to recognize the additional need to measure the quantity of a food product remaining in order to create a fully effective food monitoring system. As previously discussed, the additional features of the present invention herein enables the system and the user to also monitor the amount of food remaining, so they can make more intelligent decisions about the consumption and restocking of these food products.

The prior art of U.S. Pat. No. 6,341,271 and others discussed therein also need to be recognized herein. This invention recognizes the added features of a precise inventory monitoring and control system in an industrial setting. Containers similar to, but much larger than the smart containers invented in the present invention are used to monitor the quantity remaining and identification of industrial products across a wide network. Containers that are monitored therein include a silo, storage bin, warehouse, hopper, and the like. The present invention adds to the art with the invention of a much smaller container to monitor one or more household consumable items in one or more home storage areas for use in the household item inventory monitoring and control system also invented herein.

Similarly, U.S. Pat. No. 5,671,362 protects the invention of shelves with built in sensors to monitor inventory also in an industrial environment. Such shelves would be impractical for use in home storage areas considering their increased size and different function, and again include sensors constructed as part of the shelves, similar to the previously discussed U.S. Pat. No. 6,204,763.

U.S. Pat. No. 5,950,487 describes an invention to measure the liquid level in a tank, again in an industrial setting, but fails to recognize this need in a household setting. Similarly, U.S. Pat. No. 6,218,949 discloses an invention to measure the liquid level in a cooking pot, but again fails to address the need to monitor the inventory of food items. An embodiment of the present invention fulfills this need using similar float sensors.

U.S. Pat. No. 5,715,555 protects an invention using tags attached to clothing garments to instruct the washing machine how to properly wash the clothes within. However, this invention fails to recognize the use of different types of soap that may be used in a washing machine, and thus different washing instructions may be required, further depending on the type of clothes to be washed. A preferred embodiment of the present invention addresses this problem by also enabling washing instructions to be read from a container of laundry detergent, and further adds the ability to monitor and control the inventory of that detergent.

Again addressing the needs for household devices to connect to the internet, the customer premise gateway as disclosed in U.S. Pat. Application Num. 20010034754 compliments the present invention by describing in detail how the software and API portion of a preferred embodiment of the presently invented household consumable item inventory monitoring and control system could be implemented by someone skilled in the art.

### BRIEF SUMMARY OF THE INVENTION

The invention and implementation of novel smart containers, a container interface unit, and methods therein vastly improve the household consumable item inventory monitoring and control system of the present invention over an existing household consumable item inventory monitoring and control system and related art described above.

The smart containers and container interface unit invented herein enable the household consumable items inventory monitoring and control system using one or more of those smart containers, also invented herein, to effectively monitor and control the inventory of household consumable items wherever such items are located within household storage areas. By implementing sensing and identification means as part of a smart containing unit that can be located anywhere inside a home storage area, the system can retrieve the amount remaining and identification information of the household consumable items without requiring those items to be in dedicated places, as in the previous art.

One preferred embodiment of the present invention implements the just mentioned smart containing unit using a novel smart container included in the containing unit which itself contains one or more containers that are typically associated with household consumable items. For example, this preferred embodiment includes a smart container that attaches to the bottom, side, or top of a milk jug, for example. Thus enabling the system to monitor and control the inventory of the milk wherever it is located in the refrigerator, while using existing containers typically associated with the milk.

Another embodiment of the present invention includes the construction of the smart portion of the containing unit as part of a container typically associated with a household consumable product. For example, the milk jug as previously mentioned would be purchased as a unit that includes the smart container portion attached or constructed in the side, bottom, or cap of the milk container, for example.

Yet another embodiment of the present invention includes the reuse of a smart containing unit. In this embodiment the household consumable item to be replenished would be transferred from the container that it is typically associated with into a smart container which would then implement the smart containing unit features as described herein.

Furthermore, a preferred embodiment of the present invention includes using sensors placed on the surface of a shelf in an existing storage area such as a cabinet or lockbox, wherein the consumable items would then be contained as they rest on top of this apparatus as invented herein. It is important to note that this embodiment is different than as previously invented, as those claims specifically include the construction of the sensors as part of the refrigerated or unrefrigerated compartment.

A further advantage of the present invention is that it enables the implementation of a household consumable items inventory monitoring and control system in a home without requiring either the appliance manufacturers to design and build new appliances, or the consumers to purchase new appliances or build new home storage areas. This results in an overall cost savings and convenience for everyone.

Though the present invention does not require newly designed appliances or home storage areas, it is also claimed herein that such new devices designed to include the container interface unit, logical processing unit, and/or global access portion of the system may be advantageous in some cases. An example of such being a refrigerator or lock box with a wireless interface built in to communicate with the smart containers inside, an embedded logic processor, and global access device all as part of the refrigerator. Therein the smart containers would be used inside, and still allow the contained items to be monitored and controlled by this system wherever they are located within the storage area.

It should also be pointed out that the previously mentioned system of U.S. Pat. No. 6,204,763 does briefly, though not in the claims, recognize the use of an electronic or magnetic tag to determine the presence of an item in a refrigerator or lock box. However, such an arrangement does not enable the system to specifically measure the quantity of an item remaining within a container identified by a particular tag. The present invention discussed herein alleviates this problem as well by also providing amount remaining information along with the identification information so as to enable the system to specifically determine the quantity of an item remaining in a container, including providing that information on an identification tag.

Considering a smart container in more detail, an embodiment of the present invention includes using a float sensor to measure the liquid level remaining in a smart container for the purpose of using that information to monitor and control the inventory of that household consumable liquid. This is similar to art that has been invented in the past, but in this invention being on a smaller scale, and with the intention to monitor household consumable liquids using such a float sensor.

An even more preferred embodiment of the present invention is able to retrieve washing instructions from a box of laundry detergent. Such information is included in the household consumable item identification information within the smart container. Similarly, this invention adds to this concept by also monitoring the inventory of that detergent so as to arrange the restocking of the detergent at just the right time based on historical consumption data.

### BRIEF DESCRIPTION OF THE DRAWINGS

The advantages of the present invention will become more apparent from the detailed description in the following section, when read in conjunction with the following drawings:

FIG. 1 is a block diagram overview of the present invention, a household consumable item inventory monitoring and control system;

FIG. 2A is a block diagram of a smart container in a simplified embodiment, located inside a typical home storage area;

FIG. 2B is a block diagram of a container interface unit in a simplified embodiment, and the rest of the household consumable item inventory monitoring and control system, a logic processing unit and a global access unit;

FIG. 3A is a block diagram of a smart container in a preferred embodiment;

FIG. 3B is a block diagram of a container interface unit in a preferred embodiment, and the rest of the system;

FIG. 4A is a block diagram of a smart container in a more preferred embodiment;

FIG. 4B is a block diagram of a container interface unit in a more preferred embodiment, and the rest of the system;

FIG. 5A is a block diagram of a smart container in an even more preferred embodiment;

FIG. 5B is a block diagram of a container interface unit in an even more preferred embodiment, and the rest of the system;

FIG. 6A is a block diagram of a smart container in an exemplary, even more preferred embodiment;

FIG. 6B is a block diagram of a container interface unit in an exemplary embodiment, and the rest of the system;

FIG. 7 is a block diagram of a smart container in an alternative, even more preferred embodiment;

FIG. 8 is a block diagram overview of the present invention in an exemplary, preferred embodiment;

FIG. 9 is a block diagram overview of the present invention in an exemplary, more preferred embodiment;

FIG. 10 is a block diagram overview of the present invention in an exemplary, even more preferred embodiment;

FIG. 11 is a block diagram overview of the present invention in an exemplary, even more preferred embodiment; and

FIG. 12 is a simplified schematic illustration of a smart container in an exemplary embodiment;

### DETAILED DESCRIPTION OF THE INVENTION

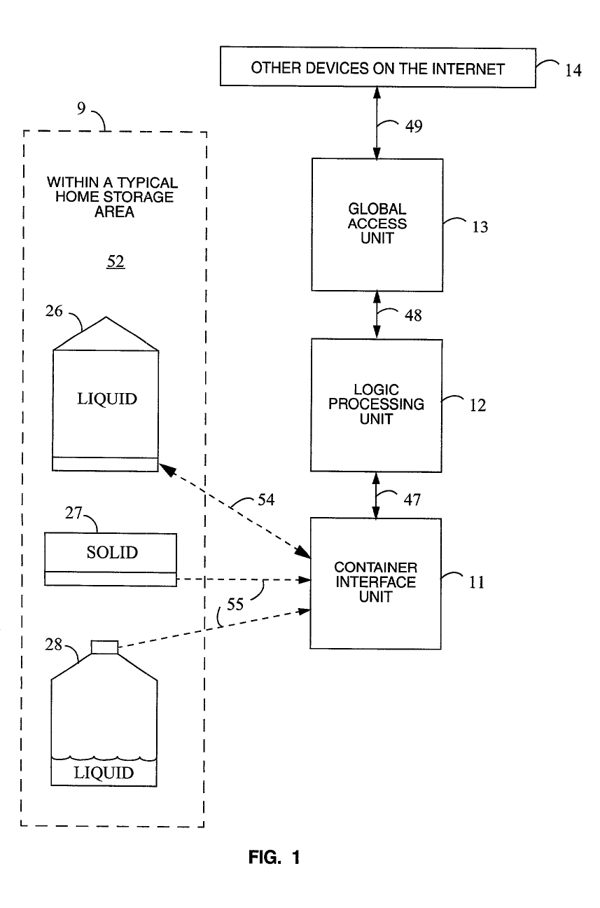

Referring now to FIG. 1 showing a block diagram overview of the present invention, a household consumable item inventory monitoring and control system. Three smart containers are shown for illustration purposes, container 26 to hold household consumable liquids, container 27 to hold solid household consumable items, and an alternate container 28 to also hold liquids.

The dotted line 9 around the three smart containers is intended to represent the boundary of a typical household storage area, where inside the dotted line, 52, is considered within the storage area. The three smart containers are drawn within the boundary 9 of a typical home storage area 52 to illustrate the improvement of this invention over the prior art, being that in the preferred embodiment the smart containers enable the system to monitor and control the inventory of the items wherever they are located within the home storage area 52.

The dotted arrows 55 drawn from each smart container 27 and 28 to the container interface unit 11 are intended to represent a general form of information transmission, specific examples of which will be described herein. The dotted arrow 54 drawn from container 26 is intended to represent a general form of information transmission and reception, specific examples of which will be described herein. The container interface unit 11 is intended to represent the means necessary to interface with the smart containers to enable the system to monitor and control the inventory of those items.

A logic processing unit 12 is shown communicating 47 with the container interface unit 11. The logic processing unit represents the means necessary to implement inventory and control methods to enable the system to monitor and control the inventory of the items in the smart containers. Examples of logic processing units 12 and communication means 47 will be described herein.

The logic processing unit 12 also communicates 48 with a global access unit 13. The global access unit includes the means necessary for the logic processing unit to execute the inventory and control methods by communicating 49 with other devices 14 on the internet. Global access means 13, logic processing means 12, and container interface unit 11 may also include means for the users of the household consumable items to themselves monitor and control the inventory of the items.

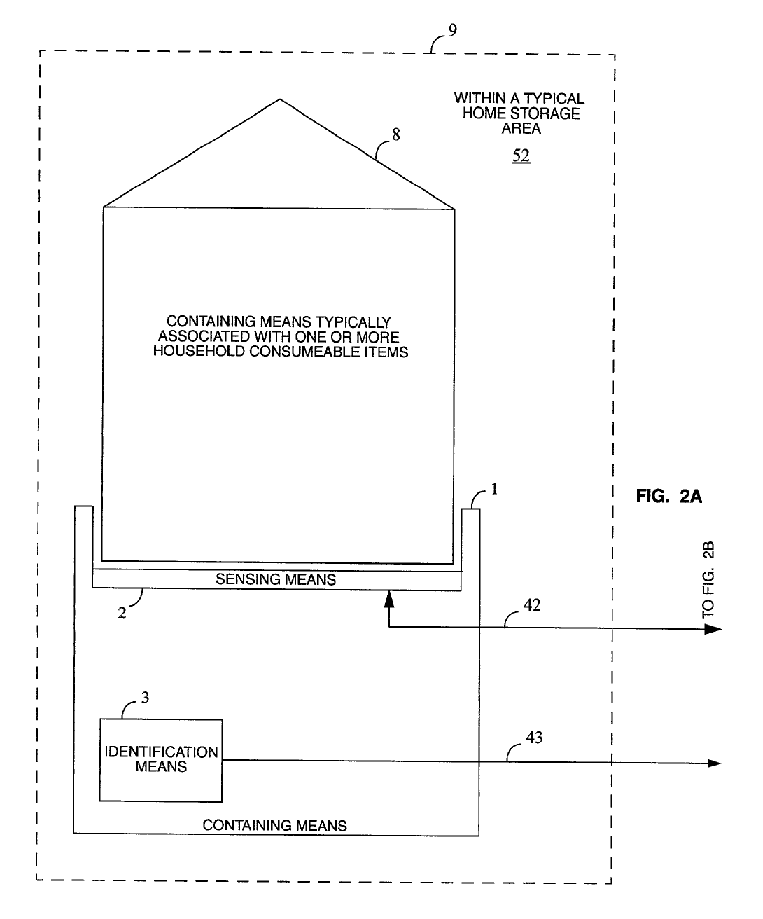

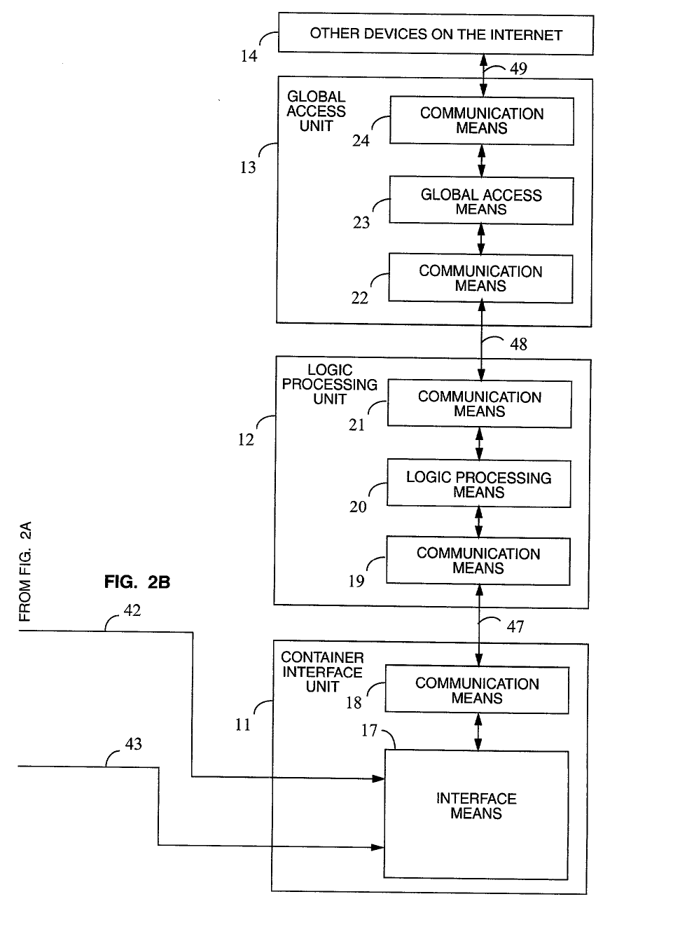

Moving on to FIG. 2A shows a block diagram of a smart container 1 in a simplified embodiment, located inside a typical home storage area 52. Such typical home storage areas include, but are not limited to, a refrigerator, pantry, cabinet, internal/external lock box, laundry room, and the like. As one skilled in the art can appreciate, there are many ways that smart containers could be used within these, or other typical home storage areas that exist today.

In this embodiment the smart container itself contains another container 8 that is typically associated with household consumable items. As one skilled in the art can appreciate, there are many ways to attach the smart container 1 to an existing container 8. This embodiment is intended to represent a way for the smart container 1 to “hug” the existing container 8, similar to the way a beer cozy hugs a can of beer or soda. Other attachment means include, but are not limited to, adhesive, elastic bands, clips, or the like. Though the smart container 1 in this embodiment is shown at the bottom of an existing container, it could also very well be attached to the side or top of the existing container.

A sensing means 2 is used by the smart container 1 to determine the amount remaining of the household consumable item 8 contained within. As one skilled in the art can appreciate, there are many ways to sense the amount remaining of a household consumable item. In this embodiment, the sensing means is intended to represent a weight sensor. Such a weight sensor could be constructed of piezoresistive material, wherein an external voltage could be applied via a wire bundle 42, and the resultant change in resistance from the weight of the contained item could be measured via another wire in the bundle 42 by an analog circuit in the container interface unit 11 pictured in FIG. 2B.

Other means of sensing include, but are not limited to, in the case of liquids using a float connected to a variable resistor or metal leads placed in the liquid to measure the change in capacitance, and in the case of solids using a spring and plunger connected to a slide potentiometer, using a similar circuit.

A smart container 1 also includes an identification means 3 to identify the item contained within. As one skilled in the art can appreciate, there are many ways to identify a household consumable item using simple circuits. In this embodiment of the present invention the identification means is intended to represent a dip switch which is set to a corresponding digital code to represent the item 8. This digital code is transmitted back via wires 43 to container interface unit 11 pictured in FIG. 2B.

Moving on to FIG. 2B shows the previously mentioned container interface unit 11 with interface means 17 to receive the said amount remaining and identification information over said wire bundles 42 and 43. As one skilled in the art can appreciate, there are many ways to interface to simple circuits in this embodiment, including, but not limited to, input port latches or Analog to Digital Converters (ADCs) which can be read by the logic processing unit 12 using communication means 18 and 47. Communication means 19 as implemented within the logic processing unit enables the logic processing means 20 to receive the said information.

As one skilled in the art can appreciate, there are many ways to implement the communication means 18, 47, and 19. Examples include, but are not limited to, RS232, power line modems over AC lines, wireless protocols such as wireless ethernet or bluetooth, or the like.

Within the logic processing unit 12 is a logic processing means 20. As one skilled in the art can appreciate, there are many devices which can be used as a logic processing means to implement household consumable item inventory monitoring and control methods. These devices include, but are not limited to, a microcontroller, embedded microprocessor, or a CPU as in a PC, in which case the PC would comprise the logic processing unit.

It should also be noted that in another preferred embodiment of this invention, though not pictured, the logic processing means could be relatively simple, in which case the household consumable item inventory monitoring and control methods would instead be implement via an internet applications provider, using global access unit 13 to carry out the necessary communication.

The logic processing unit 12 uses communication means 48 to communicate with a global access unit 13, which internally uses communication means 22 to communicate with a global access means 23 implemented therein. This global access means in turn uses communication means 24 and 49 to communicate with other devices 14 on the internet to execute the methods implemented by the logic processing unit 12. As one skilled in the art can appreciate, there are many ways to implement the communication means between logic processing unit 12, and global access unit 13. Examples include, but are not limited to, RS232, ethernet or wireless ethernet, bluetooth, cell phone type communication, satellite communication, or the like.

As one skilled in the art can also appreciate, there are many ways to implement a global access unit. These include, but are not limited to, a modem, ethernet card, or cable modem serviced by an ISP or the like. As one skilled in the art can also appreciate, there are many internet devices 14 that a household consumable item inventory monitoring and control system may communicate with to execute the methods of the logic processing unit. These devices include, but are not limited to, internet shopping servers, email servers, PDAs, cell phones, cars, and the like.

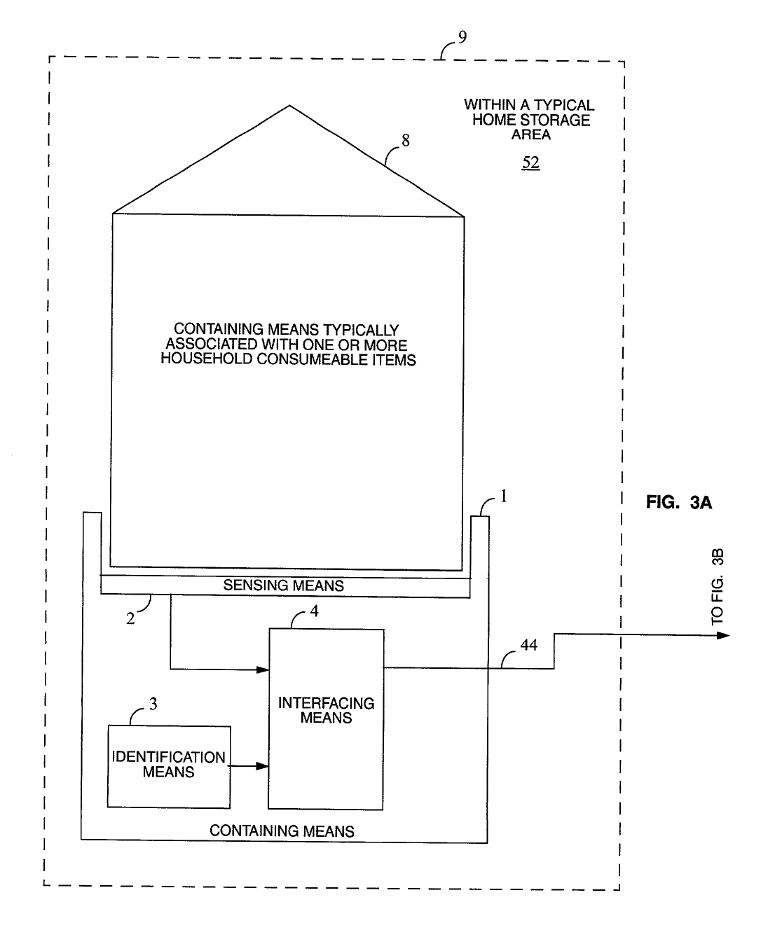

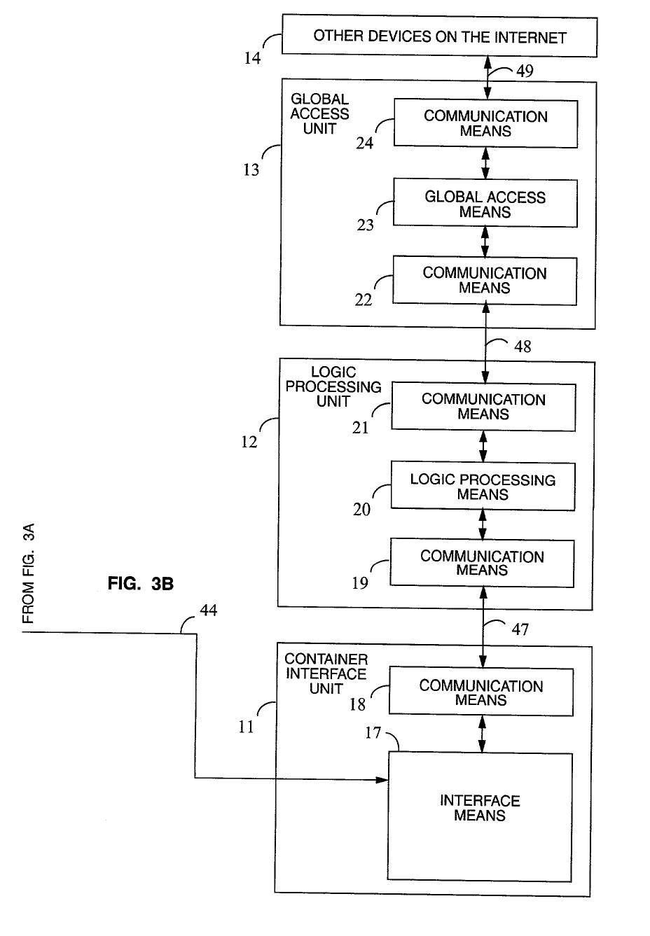

Moving to FIG. 3A shows a smart container 1 in a preferred embodiment. In this embodiment, interfacing means 4 are used to perform any signal conditioning or logic functions needed by the sensing means 2 or the identification means 3. Transmit means 44 are again used to communicate information received from the sensing 2 and identification means 3 to the container interface unit 11 as shown in FIG. 3B. Again interface means 17 are used by the container interface unit 11, which in turn communicates with the logic processing unit 12, which in turn communicates with the global access unit 13, which in turn communicates with other devices 14 on the internet to monitor and control the inventory of household consumable items contained within one or more smart containers 1.

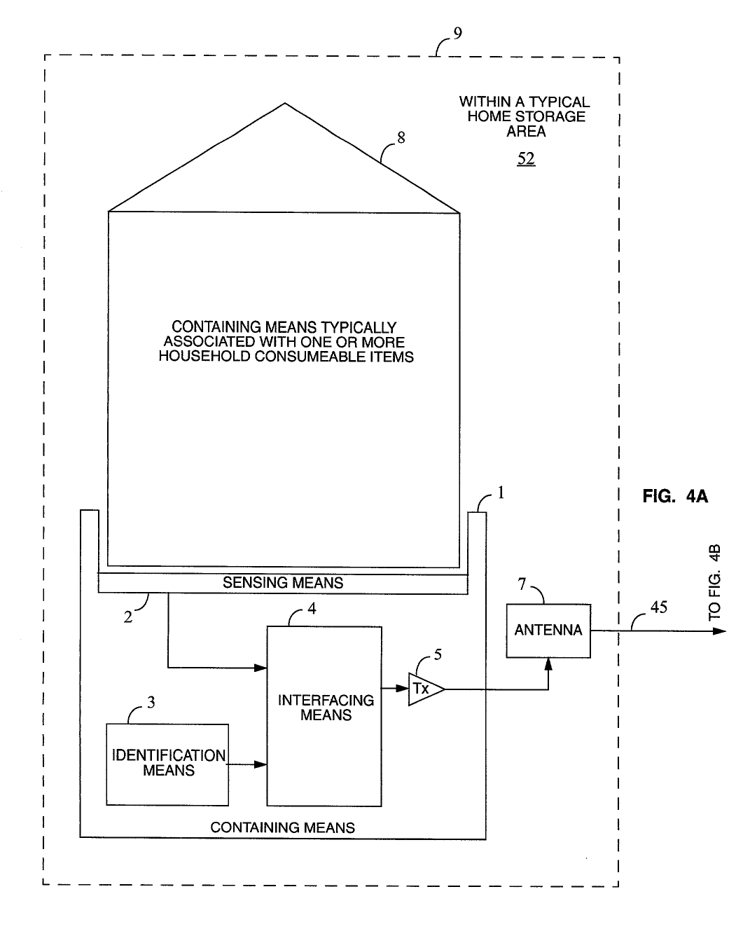

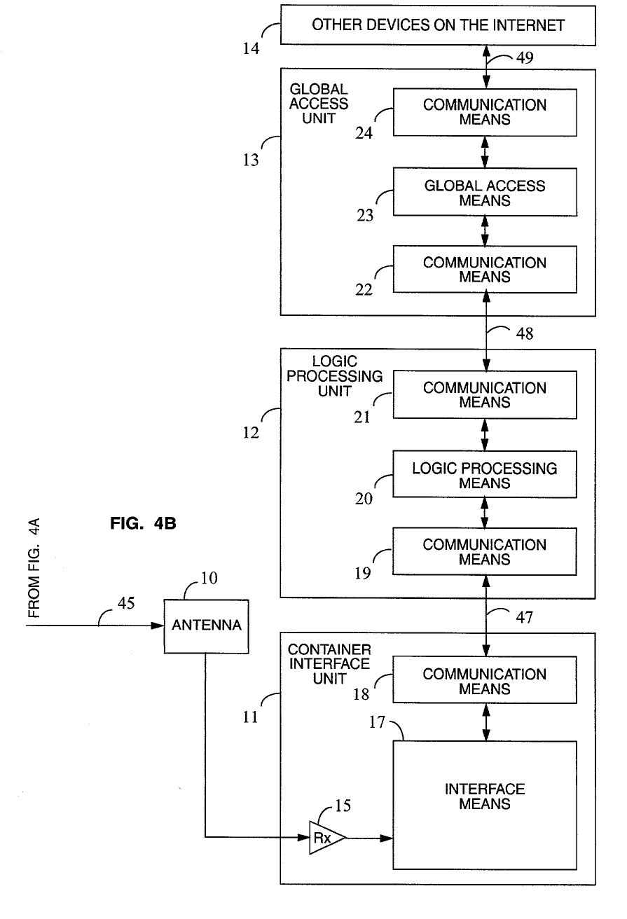

FIG. 4A shows a smart container in a more preferred embodiment. In this embodiment, interfacing means 4 communicate with a transmitter 5, which in turn, in this embodiment, uses an antenna 7 to wirelessly communicate 45 with the container interface unit 11 in FIG. 4B. As one skilled in the art can appreciate, there are many ways to implement a circuit to interface and transmit the information received from the sensing means 2 and identification means 3. Examples include, but are not limited to, a circuit that periodically reads the information from 2 and 3 and transmits it to the container interface unit 11, or a circuit that reads and transmits the information only when the amount of product 8 remaining changes.

Container interface unit 11, in this embodiment, uses an antenna 10 and receiving means 15 to communicate the information 45 to the interface means 17. As one skilled in the art can also appreciate, there are many ways to implement a circuit to receive the information from one or more smart containers 1. Although in this embodiment the transmitting 7 and receiving 10 antennas are drawn outside smart container 1 and container interface unit 11, respectively, these antennas could also be constructed internal to the units, as one skilled in the art can appreciate.

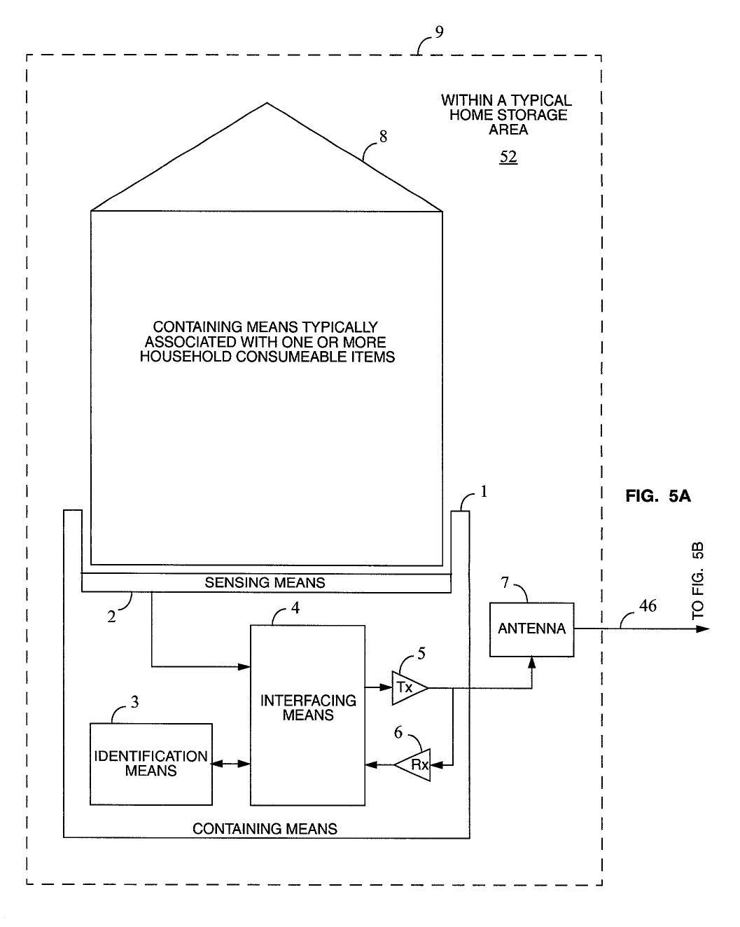

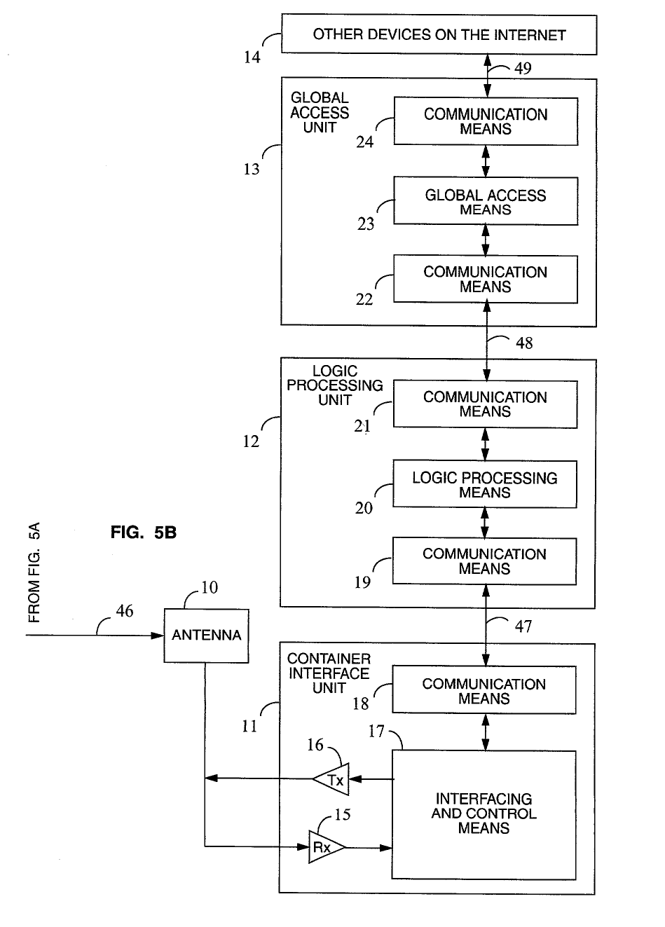

FIG. 5A-B shows a smart container 1 and container interface unit 11 in an even more preferred embodiment, along with the rest of the system. In this embodiment, smart container 1 is also equipped with receiving means 6 to wirelessly receive information signals from container interface unit 11, which in turn uses transmit means 16 to transmit these signals. As one skilled in the art can appreciate, there are similarly many ways to construct a receiving circuit 6 to be used in smart container 1. There is no doubt that these transmitting and receiving circuits would need to consume little power to be of practical use, however with the IC technology known today in the art, such circuits could be constructed that would result in reasonable battery life, if a battery were used as part of the interfacing circuit 4 in the smart container 1 in this embodiment.

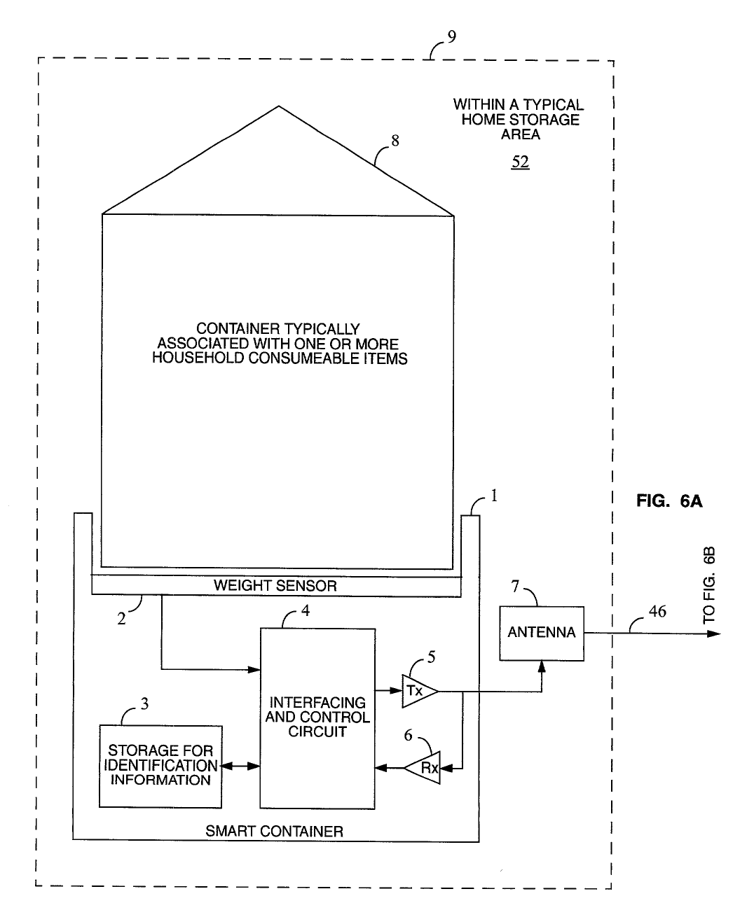

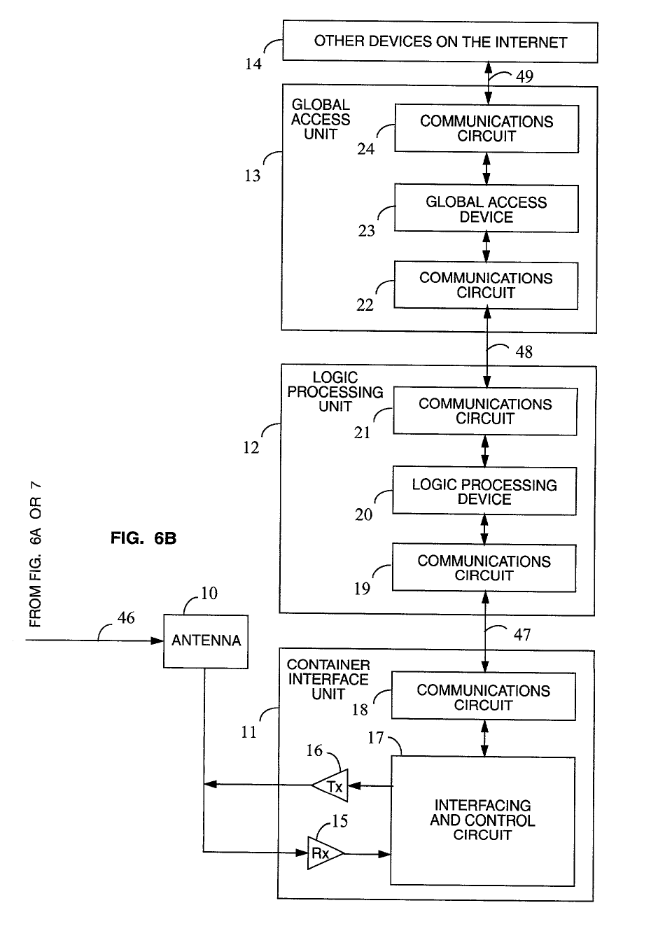

FIG. 6A-B shows an exemplary, even more preferred embodiment of a smart container 1, container interface 11, along with the rest of the system. A weight sensor 2 is shown interfacing to the control circuit 4, which in turn interfaces to a storage medium 3, transmitter 5, and receiver 6. As one skilled in the art can appreciate, a low power EEPROM could be used for the storage of the identification information of the contained item 8, including, but not limited to, identification information such as product type, product born-on date, nutritional information, and the like.

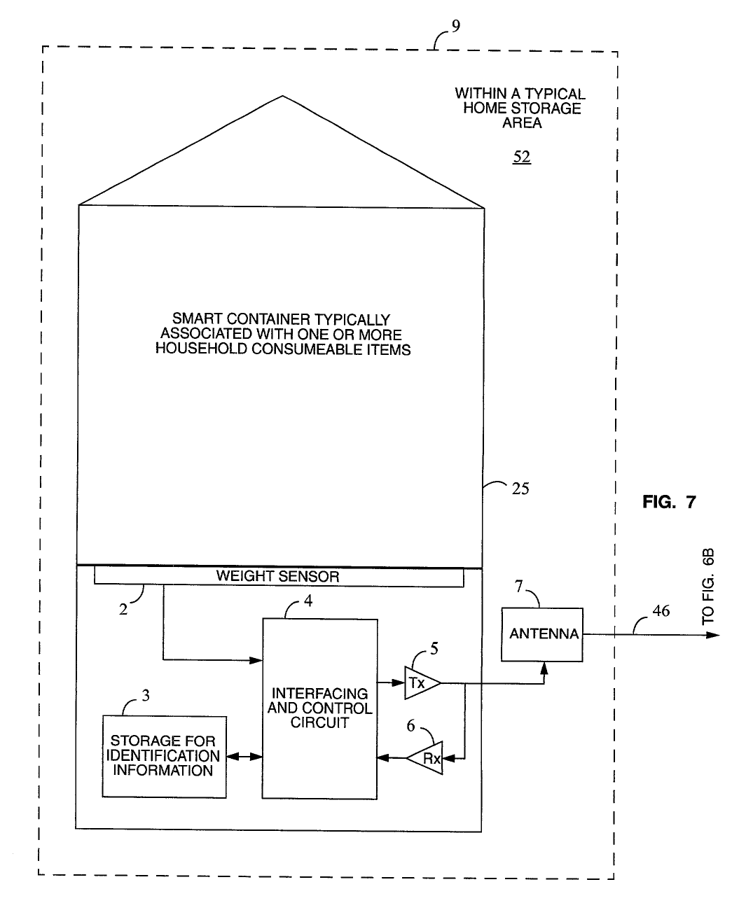

FIG. 7 shows a smart container 25 in an alternative, even more preferred embodiment. In this embodiment the smart portion of the container is instead constructed as part of a container that is typically associated with one or more household consumable items. In this way, the items could be purchased as a unit 25 with the consumable product contained inside, or the product could be purchased separately, and transferred to the container 25 upon receipt form a vendor. Similar means are used in the rest of the system in this embodiment to monitor and control the inventory of the one or more items contained by one or more smart containers 25.

In this embodiment, it is important to note that in the case where the consumable product is purchased separately, and later transferred to the container 25, that the identification information 3 therein may need to be updated if the new product is different from the old. In this case the receiving means 6 are used to update the information as instructed by the global accesses means 13 or logic processing unit 12, via the container interface unit 11.

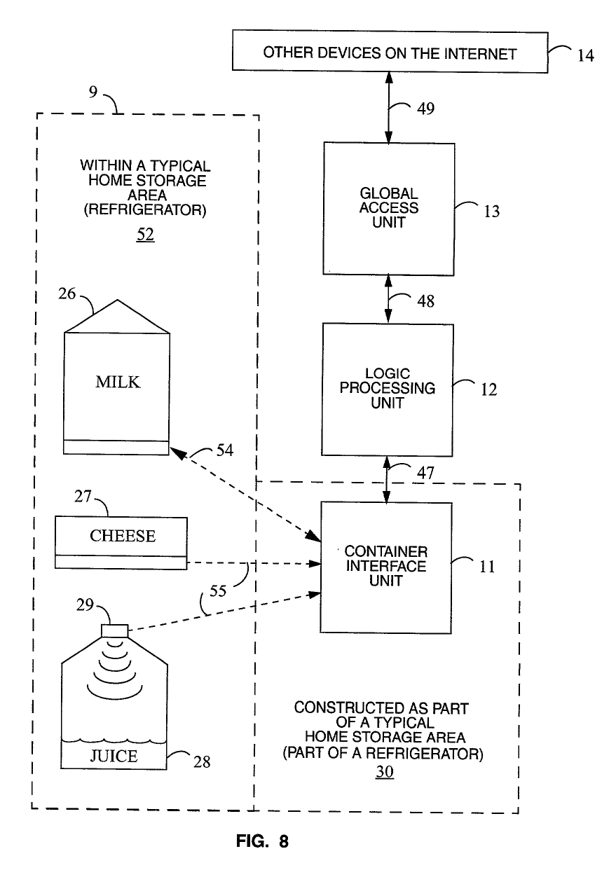

FIG. 8 shows the present invention in an exemplary, preferred embodiment. In this embodiment the container interface unit 11 is instead constructed as part of 30 the typical home storage area 52. In this exemplary embodiment, the home storage area shown is a refrigerator, wherein the refrigerator uses communication means 47 to communicate with the logic processing unit 12. One skilled in the art can appreciate that there are many ways to construct the container interface unit as part of a home storage area 52. These areas could include, but are not limited to, being constructed as part of a pantry, cabinet, internal/external lock box, laundry room shelf, or the like.

It should also be pointed out that in an alternative embodiment not pictured, the container interface unit 11, logic processing unit 12, or global access unit 13 could either individually or together be used inside a typical home storage area but not constructed as part of that area. An example of this embodiment uses these one or more units by laying them on the shelf of the home storage area 52 so as to interface and contain the smart containers above them.

A more preferred means of sensing is also pictured 29 in this figure. In this case ultrasonic or similar waves could be used to measure the level of product within smart container 28. Using very small scale IC technology, the wave interface along with a smart container wireless interface could be used to implement this embodiment.

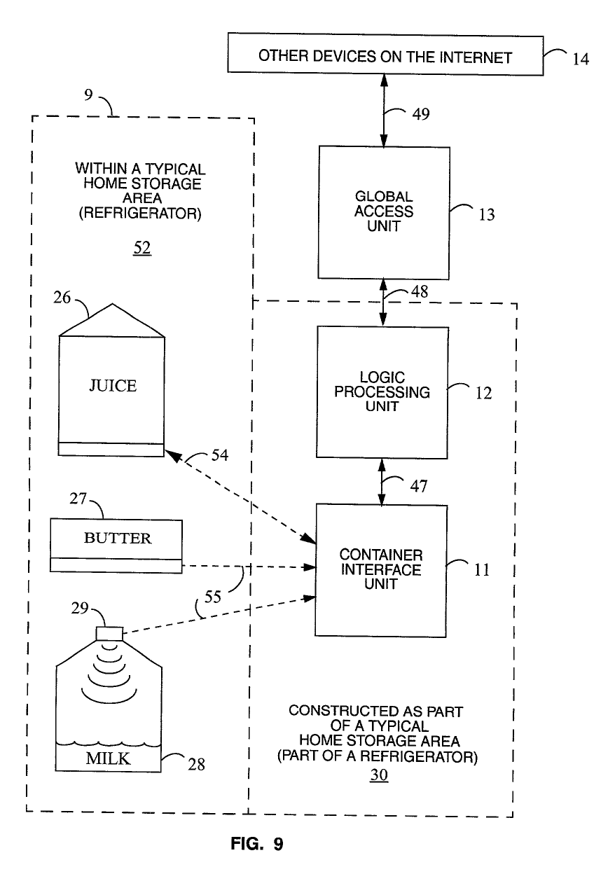

FIG. 9 shows the present invention in an exemplary, more preferred embodiment. In this embodiment both the container interface unit 11 and logic processing unit 12 are constructed as part of 30 the typical home storage area 52, and use communication means 48 to communicate with the global access unit 13, similarly as described above.

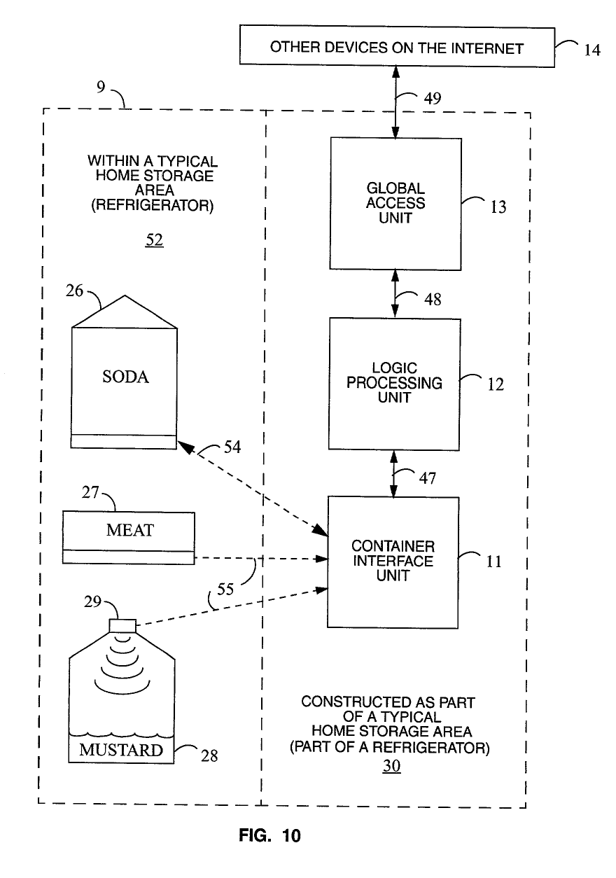

FIG. 10 shows the present invention in an exemplary, even more preferred embodiment. In this embodiment all three units including the container interface unit 11, logic processing unit 12, and global access means 13 are constructed as part of 30 the typical home storage area 52, in which case the refrigerator communicates 49 with other devices 14 on the internet, similarly as described above.

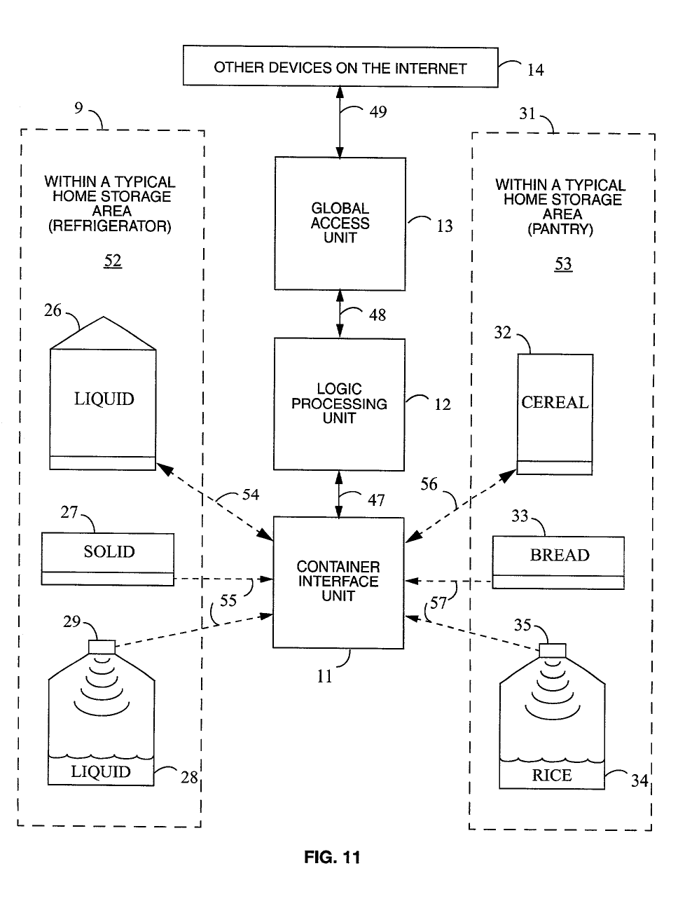

FIG. 11 also shows the present invention in an exemplary, even more preferred embodiment. In this embodiment the container interface unit 11 additionally interfaces with one or more smart containers 32, 33, and 34 located in a separate home storage area, a pantry as is shown in this drawing. Communication means 56 and 57, and sensing means 35 are similar to those pictured in storage area 9, however may use different sensing, interfacing, or communication techniques.

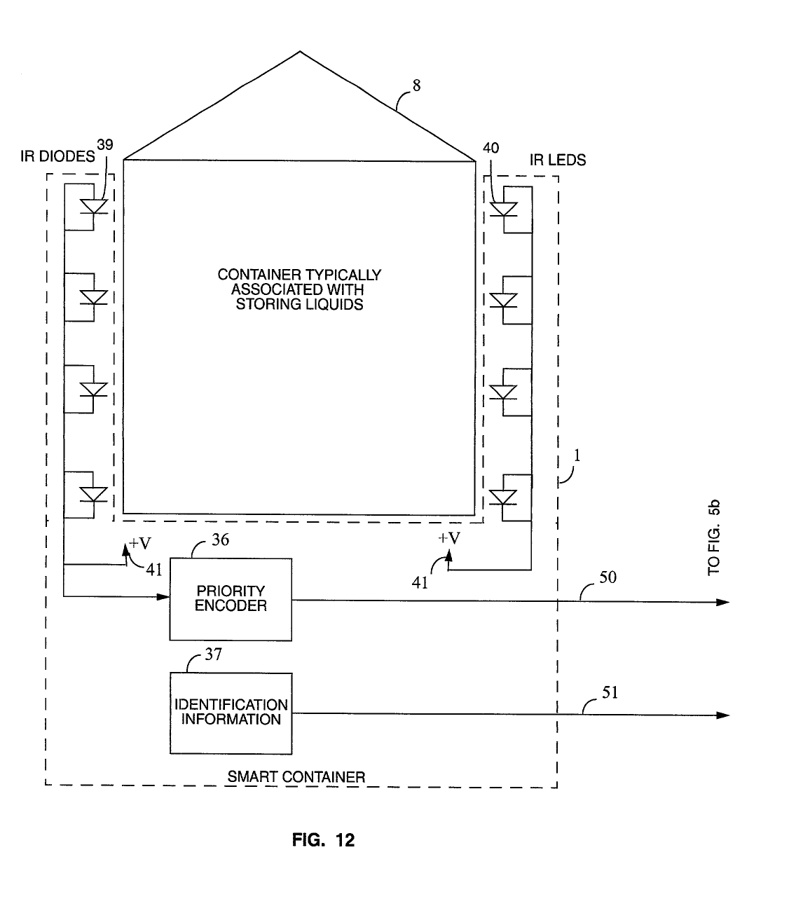

FIG. 12 is a simplified schematic illustration of a smart container in an exemplary embodiment. In this embodiment InfraRed (IR) LEDs 40 and diodes 39 are used to sense the amount of product remaining in container 8 by creating IR beams across the container which are broken by the presence of product. A voltage 41 is applied to LEDs 40 and diodes 39 so as to create the a logic high reference level. A priority encoder 36 is used to encode the logic high levels produced by diodes 39 upon receipt of the IR beams. This data is transmitted 50 back to the container interface unit 11. Similarly, identification information 37 is also transmitted 51 back to unit 11 as previously described.

Referencing again FIG. 5A-B, the logic processing unit 12 implements novel methods to monitor and control the inventory of household consumable items contained by smart containers. In general, the steps of these methods include getting the household consumable item information from one or more smart containers in the system, determining which items are needed, ordering one or more items that are needed from one or more vendors, and restocking the items received in the one or more home storage areas.

Continuing to reference FIG. 5A-B, beginning with the step of getting the household consumable item information, one or more smart containers 1 determine the amount remaining using one or more sensors 2 and identification means 3, of the one or more items 8 they contain. Transmit means 5 is used to communicate the item information to container interface unit 11, possibly also using receiving means 6 in the process of communicating the information. This step of getting the household item information may also include getting more detailed consumable item information such as nutritional or cooking information from food products, or washing instructions from laundry detergent, for example.

Similarly, receiving means 6 could also be used to store updated household consumable item information, including but not limited to, updated consumable item identification, including nutritional information.

The step of determining may include, but is not limited to, determining which one or more items 8 are at a critical level, determining which one or more items 8 are currently on order by referencing stored state information inside logic processing means 20, or considering product rate of consumption based on previous data stored in logic processing means 20. This step may further include considering whether the product shelf life has expired by referencing a date code stored in identification means 3 and comparing it to the date as read in by the logic processing means 20 either via a RTC or via the global accesses unit 13, generating a list of which one or more products are needed, and communicating this list to the users of the items via global access unit 13 and one or more of the previously mentioned user interface devices, or another device. Furthermore, the methods for inventory monitoring and control available to the user may further include adding or deleting one or more items to the list, approving or denying the list, or setting up the system so as to be notified at a later date.

Referencing again FIG. 5A-B, the step of ordering implemented by the logic processing unit 12 may further include seeking the lowest bidder for one or more household items from one or more vendors, ordering these items from a vendor that delivers, wherein this step may include setting up a delivery time. Furthermore, this step of ordering from a vendor that delivers may include giving authorization to that vendor to deliver the goods to an internal/external lock box located at the delivery location. The step of ordering may further include ordering the items from a physical supplier store, such as a grocery store, wherein this step of ordering may include setting up a pickup time.

Finally, the step of restocking may include, but is not limited to, replacing the used containing units with fresh containing units containing new product, replacing used containers contained by smart containers with fresh containers containing new product, wherein said step may include updating household consumable item identification information stored in said smart containers.

This previous detailed description of the invention is provided to enable anyone skilled in the art to make or use the present invention. The various modifications to these embodiments will be readily apparent to those skilled in the art, and the generic principles defined herein may be applied to other embodiments without the use of inventive ingenuity. Therefore, the present invention is not intended to be limited to the embodiments shown herein, but rather to be in accordance with the widest view consistent with the spirit and scope of this invention.

What is claimed is:

1. An apparatus for use within a home storage area for transmitting one or more household consumable item information signals in a household consumable items inventory monitoring and control system, comprising:
containing means for containing one or more household consumable items for use within home storage areas typically associated with the storage of said items;
one or more sensing means for determining the amount remaining of the one or more household consumable items contained by said containing means;
identification means for identifying the one or more household consumable items contained by said containing means;
transmit means connected to said one or more sensing means and to said identification means for transmitting one or more household consumable item information signals received from said one or more sensing means and from said identification means; and
interface means connected to said one or more sensing means, said identification means, and said transmit means for interfacing between said one or more sensing means, said identification means, and said transmit means.

2. An apparatus for use within a home storage area for transmitting one or more household consumable item information signals, comprising:
containing means for containing one or more household consumable items for use within home storage areas typically associated with the storage of said items;
one or more sensing means for determining the amount remaining of the one or more household consumable items contained by said containing means;
identification means for identifying the one or more household consumable items contained by said containing means; and
transmit means connected to said one or more sensing means and said identification means for transmitting one or more household consumable item information signals received from said one or more sensing means and from said identification means.

3. The apparatus of claim 2, further including interface means connected to said one or more sensing means, said identification means, and said transmit means for interfacing between said one or more sensing means, said identification means, and said transmit means.

4. The apparatus of claim 3, further comprising:
reception means connected to further interfacing means for receiving one or more household consumable item information signals, wherein said one or more household consumable item information signals includes household consumable item identification information; and
said interfacing means for storing household consumable item information included in said household consumable item information signals in said identification means, wherein said household consumable item information includes household consumable item identification information.

5. In a household consumable items inventory monitoring and control system in which one or more containing units are used within one or more home storage areas for transmitting one or more household consumable item information signals, an apparatus for interfacing with said one or more containing units, comprising:
communication means for communicating with one or more containing units, including reception means for receiving one or more household consumable item information signals from said one or more containing units;
interface means connected to said communication means for interfacing between said one or more containing units and logic processing means elsewhere in the system, wherein said interface means includes transformation means for transforming said household consumable item information signals into one or more corresponding container interface information signals for transmission to said logic processing means; and
communication means connected to said interface means for communicating with said logic processing means elsewhere in the system, including transmit means for transmitting said one or more container interface information signals to said logic processing means.

6. The apparatus of claim 5, wherein:
said communication means for communicating with one or more containing units further includes transmit means for transmitting one or more household consumable item information signals to said one or more containing units, wherein said one or more household consumable item information signals includes household consumable items identification information;
said communication means for communicating with logic processing means elsewhere in the system further includes reception means for receiving one or more container interface information signals from said logic processing means, wherein said one or more container interface information signals includes household consumable items identification information; and
said interfacing means further includes transformation means for transforming container interface information signals received from said logic processing means elsewhere in the system into one or more corresponding container interface information signals for transmission to said one or more containing units.

7. The apparatus of claim 5, wherein:
said logic processing means is instead constructed as part of said apparatus;
said logic processing means includes communication means for communicating with said interface means, including reception means for receiving said one or more container interface information signals;
said logic processing means is for implementing inventory monitoring and control methods to monitor and control the inventory of household consumable items contained by said one or more containing units, including implementing inventory monitoring and control methods using household consumable item information included in said one or more container interface information signals; and
said apparatus further comprises communication means connected to said logic processing means for communicating with a global access means elsewhere in the system, including transmit means for transmitting the results of said inventory monitoring and control methods to said global access means.

8. The apparatus of claim 7, wherein:
said global access means is instead constructed as part of said apparatus;
said global access means includes communication means for communicating with said logic processing means, including reception means for receiving said results of said inventory monitoring and control methods;
said global access means is for accessing one or more other devices on the internet;
said global access means includes means for executing the results of said inventory monitoring and control methods by communicating with said one or more other devices on the internet; and
said apparatus further comprises communication means connected to said global access means for communicating with other devices on the internet.

9. A household consumable item inventory monitoring and control system, comprising:
one or more containing means for containing one or more household consumable items for use within home storage areas typically associated with the storage of said household consumable items, sensing the amount remaining of the one or more said household consumable items, identifying the said one or more household consumable items, and transmitting said amount remaining and identification information as one or more household consumable item information signals;
container interface means for receiving said one or more household consumable item information signals, transforming said household consumable item information signals into one or more corresponding container interface information signals, and transmitting said one or more container interface information signals;
logic processing means for receiving said one or more container interface information signals, implementing inventory monitoring and control methods using household consumable item information included in said one or more container interface information signals, and transmitting the results of said inventory monitoring and control methods; and
global access means for receiving said results of said inventory monitoring and control methods, accessing one or more other devices on the internet, and executing the results of said inventory monitoring and control methods by communicating with said one or more other devices on the internet.

10. The household consumable item inventory monitoring and control system of claim 9, wherein:
said one or more containing means is further for receiving one or more household consumable item information signals including household consumable item identification information, and storing said one or more household consumable item information signals including household consumable item identification information so as to update the stored household consumable item information including updating the stored household consumable item identification information;
said interface means is further for receiving one or more container interface information signals including household consumable items identification information, transforming said container interface information signals into one or more corresponding container interface information signals, and transmitting said one or more container interface information signals to said one or more containing means;
said logic processing means is further for transmitting one or more container interface information signals including household consumable items identification to said interface means, and receiving global access control signals; and
said global access means is further for transmitting global accessing control signals to said logic processing means.

11. An apparatus for use within a home storage area for transmitting one or more household consumable item information signals in a household consumable items inventory monitoring and control system, comprising:
a container for containing one or more household consumable items for use within home storage areas typically associated with the storage of said items;
one or more sensors for determining the amount remaining of the one or more household consumable items contained by said container;
an identification tag for identifying the one or more household consumable items contained by said container;
a transmitter connected to said one or more sensors and to said identification tag for transmitting one or more household consumable item information signals received from said one or more sensors and from said identification tag; and
an interfacer connected to said one or more sensors, said identification tag, and said transmitter for interfacing between said one or more sensors, said identification tag, and said transmitter.

12. An apparatus for use within a home storage area for transmitting one or more household consumable item information signals, comprising:
a container for containing one or more household consumable items for use within home storage areas typically associated with the storage of said items;
one or more sensors for determining the amount remaining of the one or more household consumable items contained by said container;
an identification tag for identifying the one or more household consumable items contained by said container; and
a transmitter connected to said one or more sensors and said identification tag for transmitting one or more household consumable item information signals received from said one or more sensors and from said identification tag.

13. In a household consumable items inventory monitoring and control system in which one or more containing units are used within one or more home storage areas for transmitting one or more household consumable item information signals, an apparatus for interfacing with said one or more containing units, comprising:
a communicator for communicating with one or more containing units, including a receiver for receiving one or more household consumable item information signals from said one or more containing units;
an interfacer connected to said communicator for interfacing between said one or more containing units and a logic processor elsewhere in the system, wherein said interfacer includes a transformer for transforming said household consumable item information signals into one or more corresponding container interface information signals for transmission to said logic processor; and
a communicator connected to said interfacer for communicating with said logic processor elsewhere in the system, including a transmitter for transmitting said one or more container interface information signals to said logic processor.

14. A household consumable item inventory monitoring and control system, comprising:
one or more containers for containing one or more household consumable items for use within home storage areas typically associated with the storage of said household consumable items, sensing the amount remaining of the one or more said household consumable items, identifying the said one or more household consumable items, and transmitting said amount remaining and identification information as one or more household consumable item information signals;
a container interface unit for receiving said one or more household consumable item information signals, transforming said household consumable item information signals into one or more corresponding container interface information signals, and transmitting said one or more container interface information signals;
a logic processor for receiving said one or more container interface information signals, implementing inventory monitoring and control methods using household consumable item information included in said one or more container interface information signals, and transmitting the results of said inventory monitoring and control methods; and
a global access unit for receiving said results of said inventory monitoring and control methods, accessing one or more other devices on the internet, and executing the results of said inventory monitoring and control methods by communicating with said one or more other devices on the internet.

15. A method for monitoring and controlling the inventory of one or more household consumable items comprising the steps of:
getting household consumable item information from one or more containing units located within one or more home storage areas;
determining which one or more household consumable items are needed;
ordering one or more household consumable items that are needed; and
restocking said one or more home storage areas with the corresponding said one or more household consumable items.

16. The method as recited in claim 15, wherein said step of getting household consumable item information further includes:
sensing the amount remaining of the one or more household consumable items contained within said one or more containing units located within one or more home storage areas;
identifying said one or more household consumable items contained within said one or more containing units; and
transmitting said amount remaining and identification information as one or more household consumable item information signals.

17. The method as recited in claim 16, further including receiving one or more household consumable item information signals wherein said signals include household consumable item identification information, and storing said household consumable item identification information so as to update the identification of the one or more household consumable items.

18. The method as recited in claim 15, wherein said step of determining which one or more household consumable items are needed further includes:
determining which one or more household consumable items are at a critical level;
determining which one or more household consumable items are currently on order;
considering the rate of consumption of one or more household consumable items;
considering whether the shelf life of one or more household consumable items has expired; or
generating a list of which one or more household consumable items are needed and communicating said list to the users of the one or more household consumable items, wherein said users available actions include:
adding one or more items to said list;
deleting one or more items from said list;
approving said list for ordering; or
denying said list.

19. The method as recited in claim 15, wherein said step of ordering one or more household consumable items that are needed further includes:
seeking the lowest bidder for one or more household consumable items from one or more household consumable item suppliers;
ordering said one or more items from a household consumable item supplier that delivers said one or more items, wherein said step of ordering includes setting up a delivery time;
ordering said one or more items from a household consumable item supplier that delivers said one or more items, wherein said step of ordering includes giving authorization to said supplier for accessing a lock box located at the intended delivery location; or
ordering said one or more items from a physical household consumable item supplier store, wherein said step of ordering may include setting up a pickup time.

20. The method as recited in claim 15, wherein said step of restocking said one or more home storage areas with the corresponding said one or more household consumable items further includes:
replacing used smart containers with fresh smart containers;
refilling used smart containers with new one or more said items; or
replacing containers contained by used smart containers with fresh containers containing new product, wherein said step may include updating household consumable items identification information.
